(19) United States
(12) Patent Application Publication
(10) Pub. No.: US 2026/0260789 A1
(43) Pub. Date: Sep. 3, 2026

(54) DATA TRANSMISSION THROUGH SUPERCONDUCTING CABLES

(71) Applicant: Microsoft Technology Licensing, LLC, Redmond, WA (US)

(72) Inventor: Ruslan NAGIMOV, Snohomish, WA (US)

(21) Appl. No.: 19/067,265

(22) Filed: Feb. 28, 2025

(51) Int. Cl. H01B 12/16; G01D 21/02; G01K 13/02

(52) U.S. Cl. CPC H01B 12/16; G01D 21/02; G01K 13/026; G01K 2203/00

(57) ABSTRACT

Technology is disclosed for data transmission over superconducting cables without a dedicated data transmission line. Control data associated with the superconducting cables is transmitted between terminations of the superconducting cable. In some embodiments, inductive coils at the termination may be used to superimpose data at a higher frequency than the electrical power for transmission over the superconductors to other terminations. In other embodiments, changes in parameters of the cryogenic fluid used to cool the superconductors may be used to transmit control data between terminations. For example, pressure changes and/or flow rate changes may be used to encode the control data. In either case, the dedicated transmission line typically accompanying a superconducting cable is not needed.

### TECHNICAL FIELD

Aspects of the disclosure are related to the field of data transmission and particularly to data transmission through superconducting cables.

### BACKGROUND

High-temperature superconducting (HTS) cables are well suited for power delivery to high-density consumers due to high current carrying capacity per cross section. Though they are named high-temperature, HTS cables need to be cooled to cryogenic temperatures to exhibit superconducting properties. Cryogenic fluid, such as liquid nitrogen, is used within the cables to maintain the cryogenic temperatures. HTS cables use extensive telemetry data for monitoring and controlling cable parameters including the flow and temperature of the cryogenic fluid. Conventionally, the telemetry data is transmitted using dedicated data cables that are physically placed alongside the superconducting cables. The requirement of the dedicated data cables prevents full realization of the benefits of rapid cable deployment of superconducting cables and increases the cost associated with superconducting cables. Accordingly, improvements are needed.

### OVERVIEW

Technology is disclosed herein that reduces or eliminates the need for dedicated data cables running alongside superconducting cables. The disclosed technology provides data transmission using the existing superconducting cables. Furthermore, the technology may be used in other pneumatic and hydraulic systems in which pumps, pressure transducers, pressure sensors, and/or flow rate sensors are used. In a first embodiment, a conductive coil is inductively coupled with a superconducting joint in a termination of the superconducting cable. The conductive coil is used to inject data signals at a higher frequency than the electrical power transmission. The data may include control data for the superconducting cable such as, for example, the temperature of the cryogenic fluid used to cool the superconductors within the superconducting cable. At another termination, a second conductive coil inductively coupled to the joints in its respective termination may be used to extract the data signals representing the control data. A processor can be programmed to extract the control data from the data signals and use the control data to monitor and maintain the superconducting cable. As one example, the control data includes the temperature of the cryogenic fluid, and the processor may instruct a device, such as a control valve inletting refrigerated cryogenic fluid into the superconducting cable, to increase or decrease input of the refrigerated cryogenic fluid in the superconducting cable to modify the temperature based on the control data.

In a second embodiment, a superconducting cable has a termination with a control valve coupling the cryogenic fluid supply line and the cryogenic fluid return line. A processor can inject control data into the cryogenic fluid return line using the control valve to create pressure fluctuations (e.g., pressure dips and spikes) and/or flow rate fluctuations (collectively also referred to herein as changes to one or more parameters of the cryogenic fluid). A sensor (e.g., a pressure sensor or transducer, a flow rate sensor, or both) at a second termination can detect the pressure fluctuations and/or flow rate fluctuations, and a processor can extract or decode the control data from the pressure fluctuations and/or flow rate fluctuations. The processor can use the control data to adjust control of the superconducting cable. As one example, the control data may include the temperature of the cryogenic fluid at the first termination, and the processor may instruct a control valve to increase or decrease inlet of refrigerated cryogenic fluid in the superconducting cable to modify the temperature based on the control data.

Using either embodiment, control data may include any parameter relevant to the operation of the superconducting cable other than temperature of the cryogenic fluid. For example, the control data may include cryogenic fluid pressure, current amperage of the electrical power transmitted by the superconducting cable, voltage of the electrical power transmitted by the superconducting cable, resistance at the termination, cryogenic fluid level, cryogenic fluid flow rate, mechanical strain on the superconducting layer and stabilizers of the superconducting cable, vibrational frequency, acoustic emissions, ambient temperature at the termination, humidity at the termination, and the like.

More specifically with respect to the first embodiment described above, in some embodiments a system includes a superconducting cable that includes a number of superconductors that transmit electrical power at a first frequency (e.g., 50 Hz or 60 Hz nominal). The system further includes a termination coupled to an end of the superconducting cable, where the termination includes one or more joints. Each joint couples at least one of the superconductors to a standard conductor (e.g., a copper conductor). The termination further includes a conductive coil inductively coupled to the joints that is used to inject or receive data signals transmitted across the superconductors at a second frequency higher than the electrical power transmitted across the superconductors (e.g. at kHz frequency or higher). The system also includes a processor communicatively coupled to the conductive coil and configured to transmit the data signals representing control data of one or more parameters of the superconducting cable at the second frequency higher than the first frequency to the conductive coil.

Implementations of this embodiment may include one or more of the following features. For example, the system may include a temperature sensor configured to detect a temperature of cryogenic fluid in the superconducting cable at the termination and transmit the temperature reading to the processor, where the control data may include the temperature. In some embodiments, the system may include a second termination, which may include joints coupling the superconductors to standard conductors at this termination. The second termination may also include a second conductive coil inductively coupled to the joints in the second termination. The system may further include a second processor communicatively coupled to the second conductive coil and configured to receive the data signals representing the control data. The second processor may further be configured to transmit data signals representing different control data (e.g., collected at the second termination) to the second conductive coil. The processor at the first termination may further be configured to receive the data signals transmitted by the processor at the second termination. In other words, conductive coils at each termination may be configured to send, receive, or send and receive control data at its respective termination. Further, upon receipt of the data signals and decoding to extract the control data encoded into the data signals, the receiving processor (e.g., the second processor) may be further configured to transmit instructions to a device based at least in part on the control data. For example, based on temperature readings of cryogenic fluid at the first termination, the second processor may instruct a control valve to modify (e.g., increase or decrease) inlet of refrigerated cryogenic fluid into the superconducting cable to modify the temperature as needed. In some embodiments, the control data may include the amperage of the electrical power conducted by the superconductors, the pressure of the cryogenic fluid, or any other data relevant to operation of the superconducting cable. Implementations of the described techniques may include hardware, a method or process, or computer software on a computer-accessible medium.

More specifically with respect to the second embodiment described above, in some embodiments a system includes a superconducting cable having one or more superconductors that transmit electrical power, a cryogenic fluid supply line, and a cryogenic fluid return line. The system further includes a termination coupled to an end of the superconducting cable, where the termination may include a valve coupling the cryogenic fluid supply line and the cryogenic fluid return line. The system also includes a processor communicatively coupled to the valve and configured to transmit signals to the valve to create pressure and/or flow rate changes representing control data of one or more parameters of the superconducting cable, where the pressure changes and/or flow rate changes are not sufficiently large or frequent to impact behavior of the cryogenic fluid for operation of the superconducting cable.

Implementations of this embodiment may include one or more of the following features. For example, the system may include a temperature sensor configured to detect a temperature of cryogenic fluid in the cryogenic fluid supply line at the termination and transmit the temperature to the processor. The processor may include the temperature in the control data. In some embodiments, the system includes a second termination at another end of the superconducting cable. The second termination may include a pressure sensor and a second processor communicatively coupled to the pressure sensor. The second processor may be configured to decode pressure readings from the pressure sensor to identify the control data. The second processor may be further configured to transmit instructions to a device based at least in part on the control data. For example, when the control data includes temperature of cryogenic fluid at the other termination, the device may be a control valve that controls inlet of refrigerated cryogenic fluid into the superconducting cable. As the temperature in the control data changes, the second processor may adjust the control valve to increase or decrease inlet of refrigerated cryogenic fluid to adjust the temperature as needed. In some embodiments, the control data may include the amperage of the electrical power conducted by the superconductors, the pressure of the cryogenic fluid, or any other data relevant to operation of the superconducting cable. Implementations of the described techniques may include hardware, a method or process, or computer software on a computer-accessible medium.

Additionally with respect to the second embodiment, another general aspect includes a method for transmitting data over a superconducting cable using pressure and/or flow rate fluctuations of the cryogenic fluid. The method includes obtaining control data related to the state of one or more parameters of the superconducting cable, where the superconducting cable includes one or more superconductors, a cryogenic fluid supply line, and a cryogenic fluid return line. The method further includes transmitting, via a valve coupling the cryogenic fluid supply line and the cryogenic fluid return line in a first termination of the superconducting cable, pressure changes and/or flow rate changes in the cryogenic fluid return line representing the control data, where the pressure changes and/or flow rate changes are not sufficiently large or frequent to impact operation of the superconducting cable. The method further includes detecting the pressure changes and/or flow rate changes with a pressure sensor and/or flow rate sensor coupled to the cryogenic fluid return line at a second termination of the superconducting cable and decoding the pressure changes to extract the control data. Other embodiments of this aspect include corresponding computer systems, apparatus, and computer programs recorded on one or more computer storage devices, each configured to perform the actions of the methods.

Implementations of this method may include one or more of the following features. For example, the method may include detecting a temperature of cryogenic fluid in the cryogenic fluid supply line at the termination, and including the temperature in the control data transmitted via the cryogenic fluid pressure fluctuations and/or flow rate fluctuations. The method may further include detecting pressure readings and/or flow rate readings of the cryogenic fluid in the cryogenic fluid return line at a second termination of the superconducting cable and extracting the control data from the pressure readings and/or flow rate readings. The method may further include controlling one or more parameters of the superconducting cable based at least in part on the extracted control data. In some embodiments, the control data may include any one or more parameters of the superconducting cable including, for example, temperature, amperage of the electrical power transmitted by the superconductors, pressure readings within the cryogenic fluid supply line, or any other desired data. Implementations of the described techniques may include hardware, a method or process, or computer software on a computer-accessible medium.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an exemplary system implementing inductive data transmission over a superconducting cable, according to various embodiments.

FIG. 2 illustrates additional details of the system of FIG. 1, according to various embodiments.

FIG. 3 illustrates a termination including the inductive coupling for data transmission in the system of FIG. 1, according to various embodiments.

FIG. 4 illustrates an exemplary method of using a system implementing inductive coupling for data transmission over a superconducting cable, according to various embodiments.

FIG. 5 illustrates an exemplary system implementing data transmission through fluid pressure fluctuations, according to various embodiments.

FIG. 6 illustrates additional details of the system of FIG. 5, according to various embodiments.

FIG. 7 illustrates a termination including a control valve for injecting data into the fluid of a superconducting cable, according to various embodiments.

FIG. 8 illustrates another termination including a pressure sensor for detecting the fluid pressure fluctuations injected by the control valve of FIG. 7, according to some embodiments.

FIG. 9 illustrates an exemplary method of using a system implementing data transmission through fluid fluctuations, according to various embodiments.

FIG. 10 illustrates a computing system suitable for implementing the various operational environments, architectures, processes, scenarios, and sequences discussed below with respect to the other Figures.

### DETAILED DESCRIPTION

Technology is disclosed herein that enables data transmission over a superconducting cable without the need for a dedicated data cable running alongside the superconducting cable. Superconducting cables require continuous monitoring to ensure their proper operation. For example, maintaining proper cryogenic temperatures ensures the superconductors operate with zero resistance. However, since superconducting cables transmit electrical power, dedicated data cables are traditionally run alongside the superconducting cables to transmit telemetry data between terminations of the superconducting cable. This increases time and cost of deploying superconducting cable installations. Furthermore, during operation, the data cables represent another potential point of failure.

Disclosed herein are methods for utilizing the superconducting cable itself as a way to transmit control data about the superconducting cable, avoiding the need for the dedicated data cable. A first embodiment utilizes inductive coupling at the joints in the terminations of the superconducting cables to inject higher frequency signals across the superconductors. At a first termination, a processor obtains and encodes control data about the superconducting cable. The processor sends a data signal representing the control data to a conductive coil inductively coupled to the joints in the first termination. The data signal is propagated across the superconductors to the joints at the second termination, where a second conductive coil is inductively coupled to those joints. A processor communicatively coupled to the second conductive coil receives the data signal and decodes it to extract the control data transmitted by the first processor. The processor at the second termination can use the extracted control data to modify parameters of the superconducting cable to maintain proper operation. Using the temperature example discussed above, the processor at the second termination may be able to modify inlet of refrigerated cryogenic fluid into the superconducting cable to modify the temperature reading at the other termination and maintain proper temperature levels throughout the superconducting cable.

A second embodiment utilizes pressure fluctuations and/or flow rate fluctuations in the cryogenic fluid to transmit data between terminations. At a first termination the cryogenic fluid supply line is coupled via a control valve to the cryogenic fluid return line. A processor communicatively coupled to the control valve may transmit instructions to the control valve to inject pressure fluctuations (e.g., pressure spikes or dips) and/or flow rate fluctuations representing control data into the cryogenic fluid return line. For example, the processor may obtain and encode the control data to generate the instructions for the control valve. The pressure fluctuations and/or flow rate fluctuations may be sufficiently short and infrequent to ensure they do not disrupt the operation of the superconducting cable. At the second termination, a pressure sensor and/or flow rate sensor coupled to the cryogenic fluid return line may detect the pressure fluctuations and/or flow rate fluctuations and provide the readings to a processor that decodes the pressure readings and/or flow rate readings to extract the control data. The processor at the second termination can use the extracted control data to modify parameters of the superconducting cable to maintain proper operation. Again, using the temperature example discussed above, the processor at the second termination may be able to modify inlet of refrigerated cryogenic fluid into the cryogenic fluid supply line to modify the temperature reading at the other termination and maintain proper temperature levels throughout the superconducting cable.

Advantageously, the disclosed systems and methods provide for data transmission across superconducting cables traditionally used only to transmit electrical power. By encoding control data and transmitting it across a superconducting cable via inductive coupling or pressure fluctuations in cryogenic fluid, the data is reliably transmitted without a dedicated data transmission cable. This reduces the cost and time associated with deploying superconducting cables. It also reduces the number of possible points of failure for superconducting cable installations during deployment and operation.

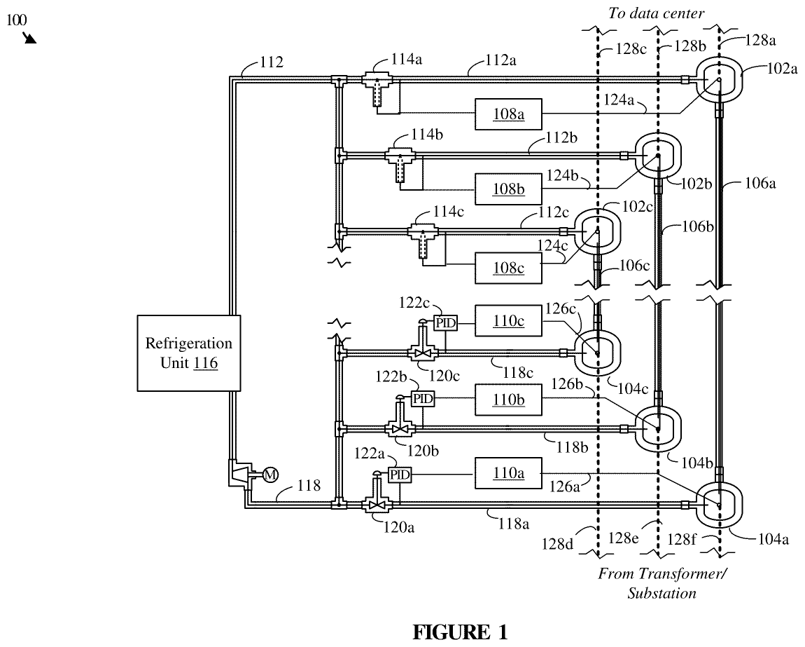

Turning now to the figures, FIG. 1 illustrates system 100. System 100 includes multiple superconducting cables 106a, 106b, 106c (collectively 106) coupled to refrigeration unit 116 for cooling cryogenic fluid (e.g., liquid nitrogen) for operation of the superconductors in each superconducting cable 106. Each superconducting cable 106 has corresponding elements for monitoring and controlling the temperature of the cryogenic fluid as discussed in more detail below. While system 100 illustrates temperature as the control data in this example, other parameters may be included in the control data for monitoring and controlling operation of the superconducting cables 106. While system 100 depicts three superconducting cables 106, any number of superconducting cables may be used in system 100.

Superconducting cables 106 include a number of superconductors extending the length of the superconducting cable. The superconductors are used to transmit electrical power (i.e., current) from one end of the superconducting cable 106 to the other end. Superconductors are conductors that conduct current with zero resistance below critical temperatures. They are designed for high-efficiency power transmission, minimizing energy losses compared to conventional copper or aluminum cables. At cryogenic temperatures, the superconductors (i.e., superconducting layer) enters the superconducting state, allowing current to flow with zero electrical resistance. This enables extremely high current densities for compact and high-capacity power transmission. Superconducting cables 106 further include a cryostat in which cryogenic liquid (e.g., liquid nitrogen) is used for maintaining low temperatures below the critical temperature. In some examples, superconducting cables 106 are high-temperature superconducting cables, and the critical temperature is approximately 77 K. High-temperature superconducting cables use materials like yttrium barium copper oxide (YBCO) or other Rare-earth barium copper oxides (ReBCO). Low-temperature superconducting cables use materials like Niobium-Titanium, often use liquid helium for cooling, and have a critical temperature below approximately 20 K. Superconducting cables 106 further often include many elements not depicted here for ease of discussion. For example, superconducting cables 106 may include a stabilizer layer typically made of copper or silver, cryogenic insulation for minimizing heat transfer to the cryostat, electrical insulation, mechanical reinforcement (e.g., stabilizers and outer sheath) to protect against stress and strain on superconducting cable 106.

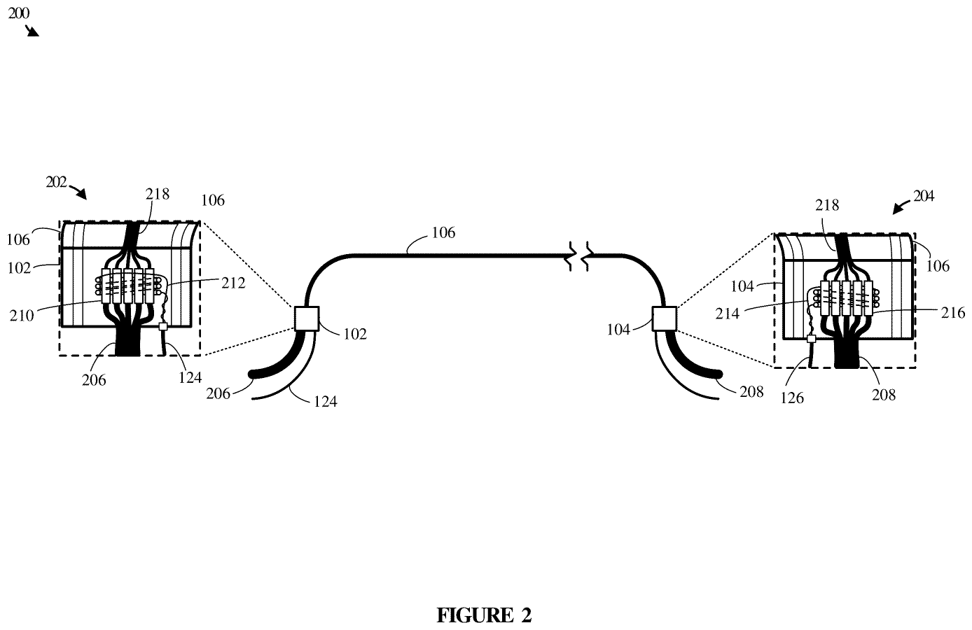

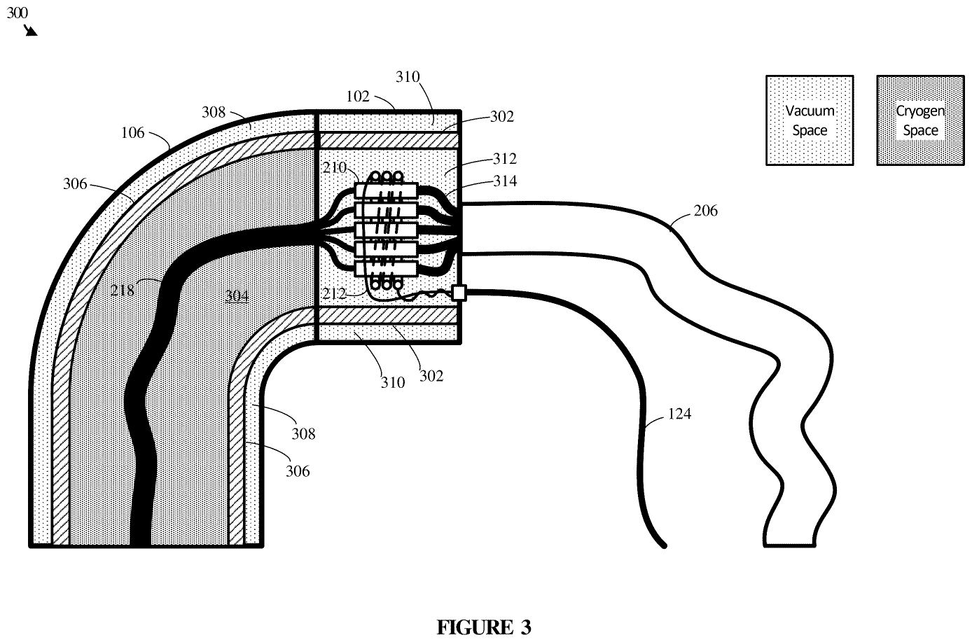

One end of superconducting cable 106 includes termination 102 (termination 102a, 102b, 102c), and the other end of superconducting cable 106 includes termination 104 (termination 104a, 104b, 104c). At terminations 102 and 104, the electrical power conducted through superconducting cable 106 enters or exits superconducting cable 106 via joints (see FIGS. 2 and 3) that connect the superconductors with traditional conducting cables 128a, 128b, 128c, 128d, 128e, 128f, which may include copper conductors, aluminum conductors, and/or steel conductors, for example. For example, termination 102 may couple a data center with superconducting cable 106. Further, termination 104 may couple superconducting cable 106 to a transformer (e.g., medium voltage to low voltage transformer), which may receive medium voltage input from a substation, for example. In such an example, electrical power from the substation may be transmitted via superconducting cable 106 to power the data center.

To maintain the operating temperature of the superconductors within superconducting cable 106, cryogenic fluid (e.g., liquid nitrogen) is cooled by refrigeration unit 116. The cryogenic fluid is transmitted via cryogenic fluid supply line 118 to termination 104 for entering superconducting cable 106. The cryogenic fluid flow is controlled by control valve 120 (control valve 120a, 120b, 120c) based on a proportional-integral-derivative (PID) control 122 (PID control 122a, 122b, 122c). PID control 122 uses setpoints to open and close control valve 120 to regulate the flow of refrigerated cryogenic fluid from refrigeration unit 116 into superconducting cable 106 to maintain the cryogenic temperatures in superconducting cable 106.

At termination 102, the cryogenic fluid exits superconducting cable 106 via cryogenic fluid return line 112 (cryogenic fluid return line 112a, 112 b, 112 c) and the temperature is obtained by temperature sensor 114 (temperature sensor 114a, 114b, 114c) prior to each cryogenic fluid return line 112 joining to form a single cryogenic return line 112. Cryogenic fluid return line 112 feeds the cryogenic fluid back into refrigeration unit 116 for cooling and reintroducing into superconducting cables 106 via cryogenic fluid supply line 118 (cryogenic fluid supply line 118a, 118 b, 118 c).

In traditional systems, the temperature read by temperature sensors 114 would be transmitted via a dedicated data cable that would extend from temperature sensors 114 alongside superconducting cables 106 to PID controls 122. PID controls 122 use the temperature readings from temperature sensors 114 to regulate the flow of refrigerated cryogenic fluid into superconducting cables 106 via control valves 120 based on setpoints to maintain the operating temperatures needed for superconducting cable 106 proper operation.

Rather than a dedicated data cable, temperature readings from temperature sensor 114 are obtained by processor 108 (processor 108a, 108b, 108c). Processor 108 encodes the temperature into data signals at a higher frequency than the power carrier frequency at which electrical power is transmitted across superconducting cable 106. For example, the power carrier frequency for alternating current (AC) may be approximately 50 hertz or 60 hertz for a standard power grid, and the power carrier frequency for direct current (DC) may be approximately zero hertz. Processor 108 may transmit the signals via signal cable 124 (signal cable 124a, 124b, 124c). Signal cable 124 may be a conductive wire ending in a conductive coil wrapped around the joints within termination 102 such that signal cable 124 is inductively coupled to the joints and therefore the superconductors within termination 102 (see FIGS. 2 and 3). Accordingly, the data signals are overlayed over the AC or DC power carrier at a frequency higher than that of the power carrier frequency. For example, the data signals may be sent at 200 hertz, 500 hertz, 1000 hertz, or any suitable frequency higher than that of the power carrier frequency. While a dedicated processor 108 is shown for each termination 102, in some embodiments a single processor 108 may be used for more than one or all of the terminations 102.

At termination 104, a second conductive coil at the end of signal cable 126 (signal cable 126a, 126b, 126c) is wrapped around the joints in termination 104. Using the signal cable 126, processor 110 (processor 110a, 110b, 110c) obtains the encoded data signal. Processor 110 decodes the data signal to extract the control data, which in this example is the temperature reading from temperature sensor 114. Processor 110 provides the temperature reading to PID control 122, which uses the temperature readings to control cryogenic fluid flow into superconducting cables 106 with control valve 120. While a dedicated processor 110 is shown for each termination 104, in some embodiments a single processor 110 may be used for more than one or all of the terminations 104.

Advantageously, system 100 does not need a dedicated data cable extending the entire length of superconducting cables 106 for telemetry data. Rather, the inductive coupling to the joints within terminations 102, 104 allows system 100 to use the superconductors within superconducting cable 106 to transmit the data.

While temperature is used in this example, any control data may be used. For example, processor 108 may receive many different forms of telemetry data associated with superconducting cables 106 and encode the data for transmission to processor 110 for decoding and use. The control data (i.e., telemetry data) may include any parameter relevant to the operation of superconducting cable 106 including temperature of the cryogenic fluid. For example, the control data may include cryogenic fluid pressure detected at termination 102, current amperage of the electrical power transmitted by superconducting cable 106 and measured at termination 102, voltage of the electrical power transmitted by superconducting cable 106 and measured at termination 102, resistance at termination 102, cryogenic fluid level measured at termination 102, cryogenic fluid flow rate measured at termination 102, mechanical strain on the superconducting layer (i.e., superconductors) and stabilizers of superconducting cable 106 measured at or near termination 102, vibrational frequency measured at termination 102, acoustic emissions measured at or near termination 102, ambient temperature at termination 102, humidity measured at termination 102, and the like, or any combination of such.

Furthermore, in some embodiments signal cables 124 and 126 may be used to send and receive data bidirectionally across superconducting cable 106. In other embodiments, multiple signal cables may be used at each termination 102, 104 so that each signal cable may be a dedicated send or receive cable. Accordingly, measurements at or near termination 104 may be transmitted across superconducting cable 106 to the conductive coil in termination 102 and obtained by processor 108 for monitoring and controlling operation of superconducting cable 106. Furthermore, the bandwidth needed for transmission of the control data (i.e., telemetry data) may be relatively low (e.g., 3200 bits/second). While the telemetry data is important, the bandwidth may be low. Bi-directional data transmission may incorporate different carrier frequencies for data transmission in different directions.

FIG. 2 illustrates additional details of one branch 200 of system 100. Branch 200 may include any of the superconducting cables 106a-106c depicted in system 100, which is generalized to superconducting cable 106 in branch 200. Superconducting cable 106 is coupled at one end to termination 102 and at the other end to termination 104. Termination 102 is shown in additional detail in expanded view 202, and termination 104 is shown in additional detail in expanded view 204. Extending from termination 102 is cable 206 which carries electrical power from superconducting cable 106 to, for example, a data center. Also extending from termination 102 is signal cable 124, which is communicatively coupled with processor 108 (see FIG. 1). Extending from termination 104 is cable 208, which provides electrical power from a substation or a transformer, for example. In some embodiments, electrical power may flow in the opposite direction described without departing from the scope of the present disclosure. Cables 206 and 208 may contain, for example, traditional copper, aluminum, or steel conductors.

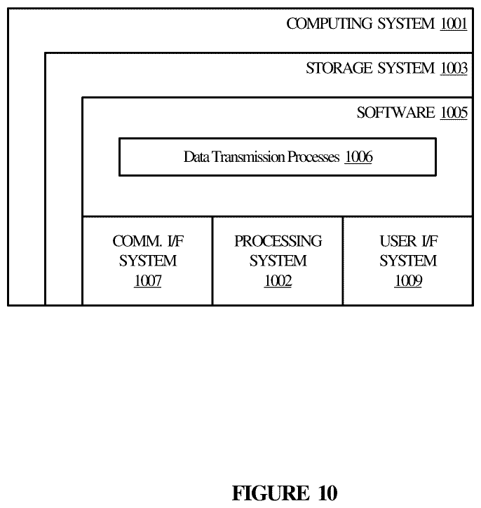

Within termination 102 as shown in expanded view 202, conductors (e.g., copper conductors) of cable 206 are coupled to superconductors 218 with joints 210. Joints 210 conductively couple the superconductors 218 (i.e., superconductor layer) with traditional conductors (e.g., copper conductors) in cable 206. However, to avoid thermal losses at joints 210, the traditional conductors are made long, which typically involves winding or repeated folding of the traditional conductors about to extend the path while keeping it compact. Further, conductive coil 212 is wrapped around joints 210 to inductively couple signal cable 124 with the superconductors 218 via joints 210. In this way, signals can be sent and received through the inductive coupling between signal cable 124 and the superconductors 218. Conductive coil 212 may be any conductor (e.g., copper conductor) and signal cable 124 may include a jacketed conductor or cable such as, for example, a copper conductor, which transmits signals between conductive coil 212 and processor 108. In some embodiments, signal cable 124 and conductive coil 212 are used only for sending or receiving signals, and in some embodiments they are used for both sending and receiving signals. In some embodiments, where conductive coil 212 and signal cable 124 are used only for sending or receiving signals, a second conductive coil and signal cable may be included in termination 102 for performing the opposite function (i.e., receiving or sending signals). Frequency of the carrier signal may differ for sending and receiving. As discussed with respect to FIG. 1, the data signals sent and received via conductive coil 212 and signal cable 124 represent control data that has been encoded or is decoded by one or more control systems including processor 108. Note that processor 108 may be, for example, computing device 1001 depicted and described with respect to FIG. 10. Additionally, other control systems may be used to transform, decode, or encode some or all of the control data for transmitting and receiving via conductive coil 212.

Within termination 104 as shown in expanded view 204, conductors (e.g., copper conductors) of cable 208 are coupled to the superconductors 218 with joints 216. Joints 216 are substantially the same as joints 210. Conductive coil 214 is wrapped around joints 216 to inductively couple signal cable 126 with the superconductors 218 via joints 216. In this way, signals can be sent and received through the inductive coupling between signal cable 126 and superconductors 218. Conductive coil 214 may be any conductor (e.g., copper conductor) and signal cable 126 may include a jacketed conductor or cable such as, for example, a copper conductor, which transmits signals between conductive coil 214 and processor 110. In some embodiments, signal cable 126 and conductive coil 214 are used only for sending or receiving signals, and in some embodiments they are used for both sending and receiving signals. In some embodiments, where conductive coil 214 and signal cable 126 are used only for sending or receiving signals, a second conductive coil and signal cable may be included in termination 104 for performing the opposite function (i.e., receiving or sending signals). Frequency of the carrier signal may differ for sending and receiving. As discussed with respect to FIG. 1, the data signals sent and received via conductive coil 214 and signal cable 126 represent control data that has been encoded or is decoded by one or more control systems including processor 110. Note that processor 110 may be, for example, computing device 1001 depicted and described with respect to FIG. 10. Additionally, other control systems may be used to transform, decode, or encode some or all of the control data for transmitting and receiving via conductive coil 214. For example, other types of devices, such as sensors (e.g., pressure sensors or transducers, current sensors, and the like) may be included in the control systems for obtaining control data and additional types of devices, such as electropneumatic positioners may be used for encoding or transforming the signals as needed by various control components within the system 100.

As seen in expanded view 202 and expanded view 204, the relevant internals of termination 102 and termination 104 are substantially similar. In other words, the conductive coil (e.g., conductive coil 212 or conductive coil 214) inductively coupling the signal cable (e.g., signal cable 124 or signal cable 126) to the superconductors in superconducting cable 106 are the same so that termination 102 and termination 104 may be either a sender, a receiver, or both a sender and receiver of control data signals.

FIG. 3 illustrates detail view 300 of superconducting cable 106 at termination 102. While termination 102 is described, as discussed above, termination 104 is substantially similar to termination 102. Detail view 300 includes superconducting cable 106, termination 102, cable 206, and signal cable 124.

Superconducting cable 106 includes insulating layer 306, and between insulating layer 306 and the outer sheath of superconducting cable 106 is vacuum space 308. Under the insulating layer 306 is a cryogen space 304 through which cryogenic fluid (e.g., liquid nitrogen) flows to keep the temperature of superconductors 218 at the operating temperature.

Termination 102 includes insulating layer 302 and between the outer shell of termination 102 and insulating layer 302 is vacuum space 310. Under the insulating layer 302 of termination 102 and surrounding joints 210 and conductive coil 212 is another vacuum space 312. Conductive coil 212 inductively couples signal cable 124 with superconductors 218 via joints 210.

Within termination 102, joints 210 are shown with a little further detail. Specifically, joints 210 conductively couple superconductors 218 to conductors 314 within cable 206. While five conductors 314, five joints 210, and five superconductors 218 are shown in FIG. 3, any number of conductors 314 may be used. Furthermore, superconductors 218 are often intertwined such that any number of superconductors 218 may be grouped in each joint 210. The exact details and number of joints 210 are not described in detail for ease of description. Rather, it is described that joints 210 are within termination 102 and inductively coupled via conductive coil 212 to signal cable 124. Conductive coil 212 is shown as having three turns about joints 210, though the number of turns may be more or fewer.

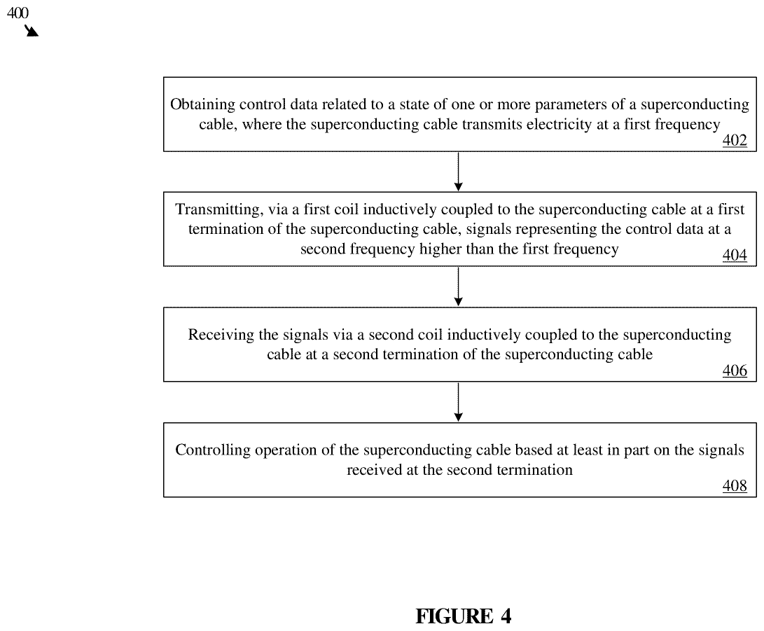

FIG. 4 illustrates method 400 for data transmission across a superconductor. Method 400 may be implemented with system 100. Method 400 may include additional steps, and the steps of method 400 may be performed in any order and/or repeatedly for continuous transmission of data and power. Method 400 begins at step 402 with a processor obtaining control data related to one or more parameters of a superconducting cable, where the superconducting cable transmits electrical power at a first frequency. For example, processor 108 may obtain control data about superconducting cable 106. As shown in FIG. 1, the control data may include temperature of cryogenic fluid in the cryogenic fluid return line 112 as measured by temperature sensor 114. Any other control data may also or instead be obtained by processor 108. For example, the control data may include any parameter relevant to the operation of superconducting cable 106 including temperature of the cryogenic fluid. For example, the control data may include cryogenic fluid pressure detected at termination 102, current amperage of the electrical power transmitted by superconducting cable 106 and measured at termination 102, voltage of the electrical power transmitted by superconducting cable 106 and measured at termination 102, resistance at termination 102, cryogenic fluid level measured at termination 102, cryogenic fluid flow rate measured at termination 102, mechanical strain on the superconducting layer (i.e., superconductors) and stabilizers of superconducting cable 106 measured at or near termination 102, vibrational frequency measured at termination 102, acoustic emissions measured at or near termination 102, ambient temperature at termination 102, humidity measured at termination 102, and the like, or any combination of such. Further, processor 108 may encode the control data for transmission. For example, processor 108 may prepare the control data for transmission at the desired frequency. Superconducting cable 106 transmits electrical power at a frequency, which may be, for example, a standard grid frequency, which is typically 50 Hertz or 60 Hertz. To ensure the control data is transmitted and extractable, the control data is transmitted at a higher frequency than the carrier frequency of the electrical power transmitted across superconducting cable 106. In other words, the control data is transmitted at a frequency higher than 60 Hertz, such as, for example, 100 Hertz, 200 Hertz, 500 Hertz, or 1000 Hertz.

At step 404, signals are transmitted via a first coil inductively coupled to the superconducting cable at a first termination of the superconducting cable. The signals represent the control data at a second frequency higher than the first frequency. For example, processor 108 may transmit signals representing the control data by transmitting the encoded control data at the higher frequency via signal cable 124 to conductive coil 212. Conductive coil 212 is inductively coupled to superconductors 218, which transmit the signal across superconducting cable 106 to termination 104.

At step 406, the signals are received via a second coil inductively coupled to the superconducting cable at a second termination of the superconducting cable. For example, processor 110 receives the signals via conductive coil 214 at termination 104. Once the signals are transmitted across superconducting cable 106 to termination 104, conductive coil 214 detects the signals, which are transmitted via signal cable 126 to processor 110.

At step 408, operation of the superconducting cable is controlled based at least in part on the signals received at the second termination. For example, processor 110 receives the signals and decodes the signals to extract the control data. Once controller 110 has the control data, instructions and information may be transmitted to relevant devices for controlling operation of superconducting cable 106. Using the temperature example described throughout, processor 110 may provide the temperature measured at temperature sensor 114 of the cryogenic fluid in cryogenic fluid return line 112. Processor 110 may provide the temperature to PID control 122 for controlling flow of refrigerated cryogenic fluid from refrigeration unit 116 by control valve 120. In some embodiments, PID control 122 may be a function performed by processor 110. In other embodiments, PID control 122 may be a separate device that uses PID to control the control valve 120. Similarly, other parameters of superconducting cable 106 may be controlled based on control data transmitted across superconducting cable 106 via inductive coupling as described with respect to the figures above.

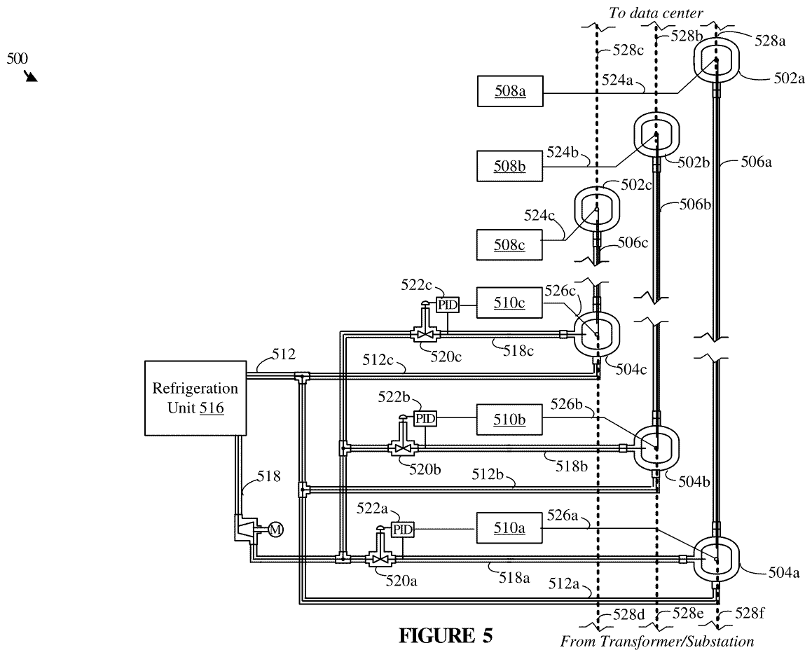

FIG. 5 illustrates system 500. System 500 includes multiple superconducting cables 506a, 506b, 506c (collectively 506) coupled to refrigeration unit 516 for cooling cryogenic fluid (e.g., liquid nitrogen) for operation of the superconductors in each superconducting cable 506. Each superconducting cable 506 has corresponding elements for monitoring and controlling the temperature of the cryogenic fluid as discussed in more detail below. While system 500 illustrates temperature as the control data in this example, other parameters may be included in the control data for monitoring and controlling operation of superconducting cables 506. While system 500 depicts three superconducting cables 506, any number of superconducting cables may be used in system 500. System 500 may be similar to system 100 described above with respect to FIG. 1 in that they are both superconducting cable systems, however, the configuration of the flow of cryogenic fluid differs as does the form of transmitting data across the superconducting cables.

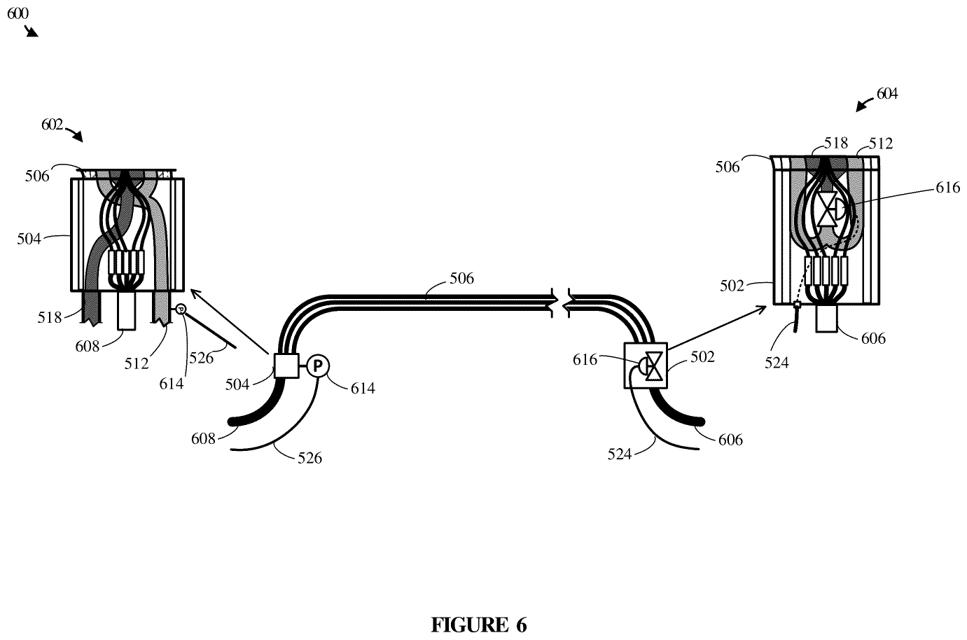

Superconducting cables 506 include a number of superconductors extending the length of the superconducting cable. The superconductors are used to transmit electrical power (i.e., current) from one end of the superconducting cable 506 to the other end. Superconductors are conductors that conduct current with zero resistance below critical temperatures. They are designed for high-efficiency power transmission, minimizing energy losses compared to conventional copper or aluminum cables. At cryogenic temperatures, the superconductors (i.e., superconducting layer) enters the superconducting state, allowing current to flow with zero electrical resistance. This enables extremely high current densities for compact and high-capacity power transmission. Superconducting cables 506 further include a cryostat in which cryogenic liquid (e.g., liquid nitrogen) is used for maintaining low temperatures below the critical temperature. Superconducting cables 506 include two cryostats including a cryogenic fluid supply line coming from refrigeration unit 516 and a cryogenic fluid return line returning to refrigeration unit 516, which will be depicted in more detail with respect to FIG. 6-8. In some examples, superconducting cables 506 are high-temperature superconducting cables, and the critical temperature is approximately 77 K. High-temperature superconducting cables use materials like yttrium barium copper oxide (YBCO) or Rare-earth barium copper oxides (REBCO). Low-temperature superconducting cables use materials like Niobium-Titanium, often use liquid helium for cooling, and have a critical temperature below approximately 20 K. Superconducting cables 506 further often include many elements not depicted here for ease of discussion. For example, superconducting cables 106 may include a stabilizer layer typically made of copper or silver, cryogenic insulation for minimizing heat transfer to the cryostat, electrical insulation, mechanical reinforcement (e.g., stabilizers and outer sheath) to protect against stress and strain on superconducting cable 506, and the like.

One end of superconducting cable 506 includes termination 502 (termination 502a, 502b, 502c), and the other end of superconducting cable 506 includes termination 504 (termination 504a, 504b, 504c). At terminations 502 and 504, the electrical power conducted through superconducting cable 506 enters or exits superconducting cable 506 via joints (see FIG. 6-8) that connect the superconductors with traditional conducting cables 128a, 128b, 128c, 128d, 128e, 128f, which may include copper conductors, aluminum conductors, and/or steel conductors, for example. For example, termination 502 may couple a data center with superconducting cable 506. Further, termination 504 may couple superconducting cable 506 to a transformer (e.g., medium voltage to low voltage transformer), which may receive medium voltage input from a substation, for example. In such an example, electrical power from the substation may be transmitted via superconducting cable 506 to power the data center.

To maintain the operating temperature of the superconductors within superconducting cable 506, cryogenic fluid (e.g., liquid nitrogen) is cooled by refrigeration unit 516. Refrigeration unit 516 may be substantially similar to refrigeration unit 116 described with respect to FIG. 1. The cryogenic fluid is transmitted via cryogenic fluid supply line 518 to termination 504 for entering superconducting cable 506. The cryogenic fluid flow is controlled by control valve 520 (control valve 520a, 520b, 520c) based on a proportional-integral-derivative (PID) control 522 (PID control 522a, 522b, 522c). PID control 522 uses setpoints to open and close control valve 520 to regulate the flow of refrigerated cryogenic fluid from refrigeration unit 516 into superconducting cable 506 to maintain the cryogenic temperatures in superconducting cable 506.

At termination 502, the cryogenic fluid is returned to a cryogenic fluid return line that flows within superconducting cable 506 and exits superconducting cable 506 at termination 504 via cryogenic fluid return line 512 (cryogenic fluid return line 512a, 512b, 512c). Within or near termination 502, the temperature of the cryogenic fluid may be obtained via temperature sensor (not shown). Cryogenic fluid return line 512 feeds the cryogenic fluid back into refrigeration unit 516 for cooling and reintroducing into superconducting cables 506 via cryogenic fluid supply line 518 (cryogenic fluid supply line 518a, 518b, 518c).

In traditional systems, the temperature read at termination 502 would be transmitted via a dedicated data cable that would extend from termination 502 alongside superconducting cables 506 to PID controls 522. PID controls 522 use the temperature readings to regulate the flow of refrigerated cryogenic fluid into superconducting cables 506 via control valves 520 based on setpoints to maintain the operating temperatures needed for proper operation of superconducting cable 506.

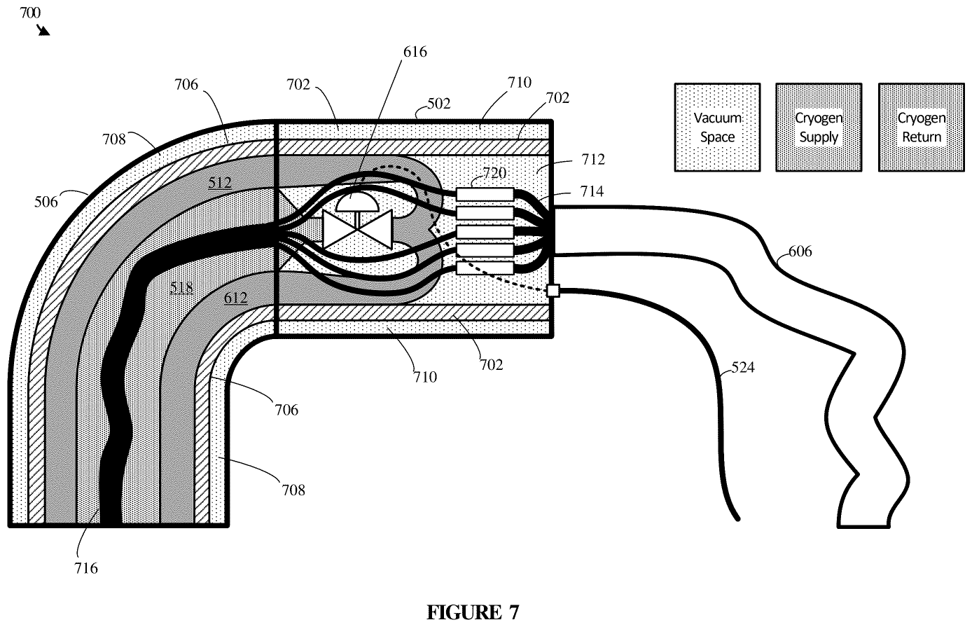

Rather than a dedicated data cable, temperature readings at termination 502 are obtained by processor 508 (processor 508a, 508b, 508c). Processor 508 encodes the temperature into data signals for transmission through pressure fluctuations or flow rate fluctuations in the cryogenic fluid return line as will be described in more detail with respect to FIG. 6-8. Processor 508 may transmit the signals via signal cable 524 (signal cable 524a, 524b, 524c). Signal cable 524 may be a conductive wire that controls a valve (see FIGS. 6 and 7) that may introduce the signals as pressure fluctuations and/or flow rate fluctuations in the cryogenic fluid return line that extends within superconducting cable 506. In some embodiments, other control devices, such as an electropneumatic positioner, may receive the signals from processor 508 via signal cable 524 and control the valve within termination 502 to introduce the pressure fluctuations and/or flow rate fluctuations. The pressure fluctuations and/or flow rate fluctuations may represent the control data (e.g., temperature readings) at termination 502. This works because the way the PID control 522 keeps the temperature and pressure of the cryogenic fluid operating within the setpoints looks a little like a low frequency (e.g., 1 hertz) signal. A similar PID control and functionality exists within termination 502 associated with the control valve within termination 502. Therefore, the changes overlaid by opening and closing the valve within termination 502 is like a different frequency signal that does not impact the PID control of system 500 but can be used to transmit the data. In other words, the opening and closing the valve within termination 502 is not frequent enough or long enough or open enough to create sufficient pressure fluctuations to impact operation of superconducting cable 506. While a dedicated processor 508 is shown for each termination 502, in some embodiments a single processor 508 may be used for more than one or all of the terminations 502.

At termination 504, a sensor or transducer (e.g., pressure sensor, pressure transducer, and/or flow rate sensor) detects the pressure fluctuations and/or flow rate fluctuations. Using signal cable 526 (signal cable 526a, 526b, 526c), processor 510 (processor 510a, 510b, 510c) obtains the pressure readings from the pressure sensor and/or flow rate readings from the flow rate sensor. Processor 510 decodes the pressure fluctuations and/or flow rate fluctuations to extract the control data, which in this example is the temperature reading of the cryogenic fluid obtained at or near termination 102. Processor 510 provides the temperature reading to PID control 522, which uses the temperature readings to control cryogenic fluid flow into superconducting cables 506 with control valve 520. While a dedicated processor 510 is shown for each termination 504, in some embodiments a single processor 510 may be used for more than one or all of the terminations 504.

Advantageously, system 500 does not need a dedicated data cable extending the entire length of superconducting cables 506 for telemetry data. Rather, the pressure fluctuations and/or flow rate fluctuations in the cryogenic fluid return line introduced at terminations 502 and read at terminations 504 allows system 500 to use the cryogenic fluid flow within superconducting cable 506 to transmit the data.

While temperature is used in this example, any control data may be used. For example, processor 508 may receive many different forms of telemetry data associated with superconducting cables 506 and encode the data for transmission to processor 510 for decoding and use. The control data (i.e., telemetry data) may include any parameter relevant to the operation of superconducting cable 506 including temperature of the cryogenic fluid. For example, the control data may include cryogenic fluid pressure detected at termination 502, current amperage of the electrical power transmitted by superconducting cable 506 and measured at termination 502, voltage of the electrical power transmitted by superconducting cable 506 and measured at termination 502, resistance at termination 502, cryogenic fluid level measured at termination 502, cryogenic fluid flow rate measured at termination 502, mechanical strain on the superconducting layer (i.e., superconductors) and stabilizers of superconducting cable 506 measured at or near termination 502, vibrational frequency measured at termination 502, acoustic emissions measured at or near termination 502, ambient temperature at termination 502, humidity measured at termination 502, and the like, or any combination of such.

Furthermore, in some embodiments additional signal cables and control valves may be used to send and receive data bidirectionally via the cryogenic fluid supply and return lines within superconducting cable 506. Accordingly, measurements at or near termination 504 may be transmitted across superconducting cable 506 to a pressure sensor or transducer and/or flow rate sensor in termination 502 and obtained by processor 508 for monitoring and controlling parameters affecting operation of superconducting cable 506. Furthermore, the bandwidth needed for transmission of the control data (i.e., telemetry data) may be relatively low (e.g., 3200 bits/second) helping to ensure the pressure fluctuations and/or flow rate fluctuations do not disrupt normal operation of superconducting cables 506.

System 500 depicts use of pressure fluctuations and/or flow rate fluctuations through a cryogenic fluid return line in a superconducting cable, but the concept of introducing or injecting pressure fluctuations and/or flow rate fluctuations in a fluid line that is otherwise controlled with valves and includes pressure transducers or sensors and/or flow rate sensors to transmit data works across many systems including hydraulic systems and pneumatic systems. For example, oil and gas pipelines may be able to use this technology for transmitting data.

FIG. 6 illustrates additional details of one branch 600 of system 500. Branch 600 may include any of the superconducting cables 506a-506c depicted in system 500, which is generalized to superconducting cable 506 in branch 600. Superconducting cable 506 is coupled at one end to termination 502 and at the other end to termination 504. Termination 502 is shown in additional detail in expanded view 604, and termination 504 is shown in additional detail in expanded view 602. Extending from termination 502 is cable 606 which carries electrical power from superconducting cable 506 to, for example, a data center. Also extending from termination 502 is signal cable 524, which is communicatively coupled with processor 508 (see FIG. 5). Extending from termination 504 is cable 608, which provides electrical power from a substation or a transformer, for example. In some embodiments, electrical power may flow in the opposite direction described without departing from the scope of the present disclosure. Cables 606 and 608 may contain, for example, traditional copper conductors. Further extending from termination 504 is cryogenic fluid supply line 518 and cryogenic fluid return line 512. These lines extend the length of superconducting cable 506 within the outer sheath of superconducting cable 506 and are coupled via valve 616 within termination 502 at the other end of superconducting cable 506.

Within termination 502 as shown in expanded view 604, conductors (e.g., copper conductors) of cable 606 are coupled to superconductors with joints. The joints conductively couple the superconductors (i.e., superconductor layer) with traditional conductors (e.g., copper conductors) in cable 606. These joints are substantially similar to joints 210 and 216 described with respect to FIGS. 2 and 3. As shown in expanded view 604, cryogenic fluid supply line 518 is coupled to cryogenic fluid return line 512 by valve 616. Valve 616 is controlled by signals received via signal cable 524. As discussed with respect to FIG. 5, signal cable 524 is communicatively coupled to processor 508 for sending instructions to control valve 616 for injecting changes (e.g., pressure fluctuations and/or flow rate fluctuations) into cryogenic fluid return line 512 such that the changes (e.g., pressure fluctuations and/or flow rate fluctuations) represent control data for transmission across superconducting cable 506 to termination 504. Processor 508 obtains the control data (e.g., temperature, pressure, flow rate, and/or the like) and encodes the control data into a series of instructions for injecting the pressure fluctuations and/or flow rate fluctuations into cryogenic fluid return line 512. In some embodiments, other control devices such as an electropneumatic positioner may be used between processor 508 and control valve 616 to translate the instructions into control of the control valve 616 for injecting the pressure fluctuations and/or flow rate fluctuations. The pressure fluctuations and/or flow rate fluctuations may include pressure spikes and dips that are infrequent enough, short enough, and sufficiently small amplitude to ensure that operation of superconducting cable 506 is not impacted by the data transmission via the pressure fluctuations and/or flow rate fluctuations.

Within termination 504 as shown in expanded view 604, conductors (e.g., copper conductors) of cable 608 are coupled to the superconductors with joints similarly to those in termination 502. At termination 504, cryogenic fluid return line 512 includes pressure sensor and/or flow rate sensor 614. The pressure readings of pressure sensor and/or flow rate reading of flow rate sensor 614 are transmitted to processor 510 via signal cable 526. Processor 510 may decode the pressure fluctuations and/or flow rate fluctuations to extract the control data. In the temperature example described throughout, processor 510 may provide the temperature reading to PID control 522 for maintaining proper temperature of the cryogenic fluid throughout superconducting cable 506 by controlling control valve 520. Other similar parameters may be used to otherwise control operation of superconducting cable 506. Note that PID control 522 and a similar PID control (not shown) associated with control valve 616 may ensure that the pressure readings and/or flow rate reading at sensor 614 are substantially similar to an approximately 1 Hertz signal. Accordingly, the pressure fluctuations and/or flow rate fluctuations may represent a different frequency carrier for transmitting the data via the pressure fluctuations and/or flow rate fluctuations, which are decoded by processor 510.

FIG. 7 illustrates detail view 700 of superconducting cable 506 at termination 502. Detail view 700 includes superconducting cable 506, termination 502, cable 606, and signal cable 524.

Superconducting cable 506 includes insulating layer 706, and between insulating layer 706 and the outer sheath of superconducting cable 506 is vacuum space 708. Under the insulating layer 706 is cryogen fluid return line 512 through which cryogenic fluid (e.g., liquid nitrogen) flows back toward refrigeration unit 516. Closer to superconductors 716 is cryogenic fluid supply line 518 through which cryogenic fluid flows from refrigeration unit 516 toward termination 502 where control valve 616 couples it the cryogenic fluid supply line 518 with cryogenic fluid return line 512. The cryogenic fluid flowing within cryogenic fluid supply line 518 and cryogenic fluid return line 512 helps ensure superconductors 716 remain below the critical temperature for zero resistance current flow.

Termination 502 includes insulating layer 702 and between the outer shell of termination 502 and insulating layer 702 is vacuum space 710. Under the insulating layer 702 of termination 502 is another vacuum space 712. Joints 720 conductively couple superconductors 716 with conductors 714 (e.g., copper conductors) of cable 606.

Using valve 616, pressure fluctuations and/or flow rate fluctuations are introduced or injected into cryogenic fluid return line 512. The pressure fluctuations and/or flow rate fluctuations create a signal representing control data obtained by processor 508 and encoded for transmission through the cryogenic fluid return line 512 from termination 502 to termination 504.

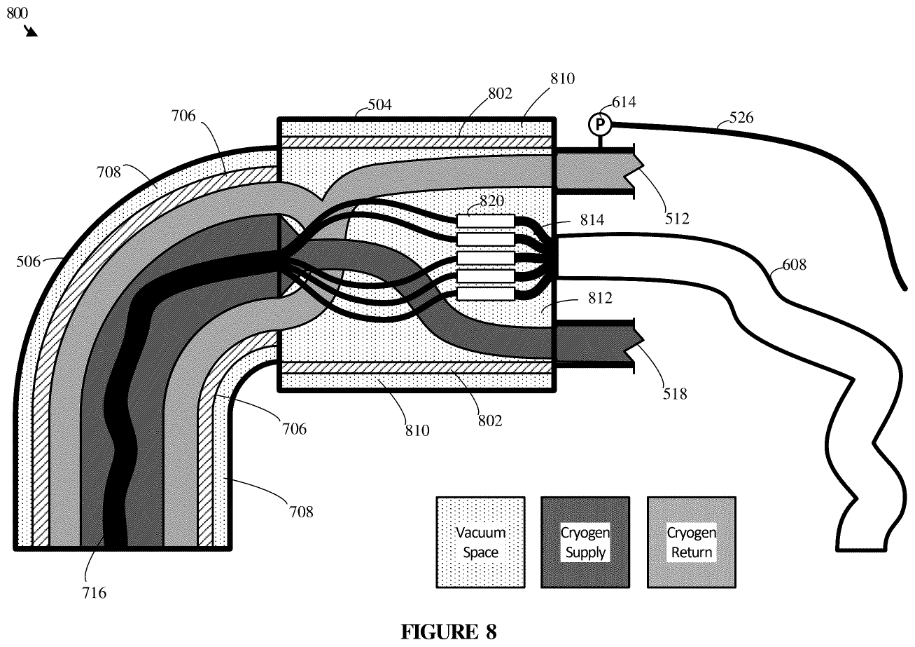

FIG. 8 illustrates detail view 800 of superconducting cable 506 at termination 504. Detail view 800 includes superconducting cable 506, termination 504, cable 608, and signal cable 526.

Superconducting cable 506 is discussed in further detail with respect to FIG. 7. Termination 504 includes insulating layer 802 and between the outer shell of termination 504 and insulating layer 802 is vacuum space 810. Under the insulating layer 802 of termination 504 is another vacuum space 812. Joints 820 conductively couple superconductors 716 with conductors 814 (e.g., copper conductors) of cable 606.

Attached to cryogenic fluid return line 512 is pressure and/or flow rate sensor 614 which measures the pressure and/or flow rate within cryogenic fluid return line 512. Pressure fluctuations and/or flow rate fluctuations introduced by control valve 616 based on signals from processor 508 to represent the control data are detected by pressure and/or flow rate sensor 614 and transmitted to processor 510 via signal cable 526. Processor 510 decodes the pressure fluctuations and/or flow rate fluctuations to extract the control data sent via control valve 616 from termination 502. Processor 510 can use the control data to send further instructions for managing control and operation of superconducting cable 506 based at least in part on the control data. For example, processor 510 can extract temperature data collected at termination 502 and sent via the pressure fluctuations and/or flow rate fluctuations to processor 510. Processor 510 can send the temperature data to PID control 522 for controlling valve 520 for modifying the temperature of the cryogenic fluid within the cryogenic fluid supply line 518 and cryogenic fluid return line 512 by allowing additional flow of refrigerated cryogenic fluid from refrigeration unit 516 via cryogenic fluid supply line 518.

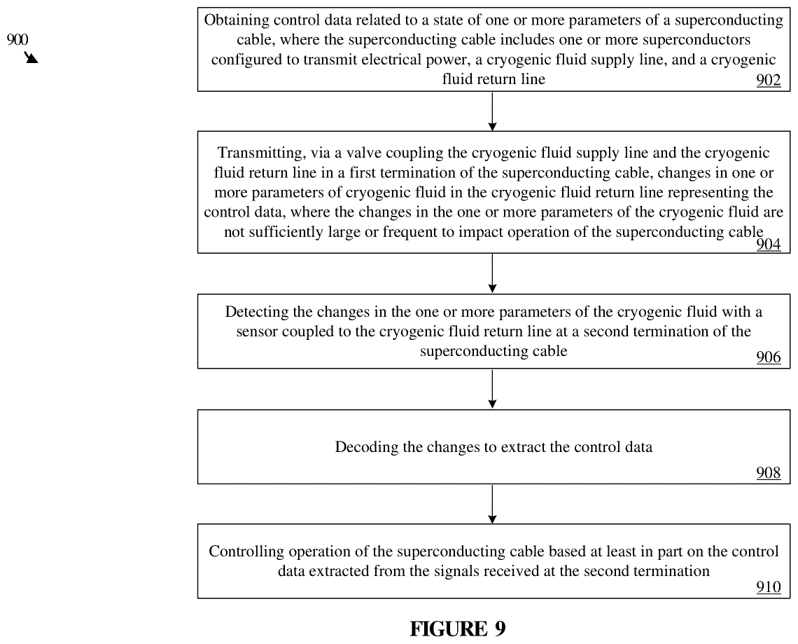

FIG. 9 illustrates a method 900 for transmitting data over a superconducting cable using pressure fluctuations and/or flow rate fluctuations within the cryogenic fluid. Method 900 may be implemented with system 500. Method 900 may include additional steps, and the steps of method 900 may be performed in any order, repeatedly for continuous transmission of data, or both. Method 900 begins at step 902 with a processor obtaining control data related to one or more parameters of a superconducting cable, where the superconducting cable transmits electrical power across superconductors and the superconducting cable includes the superconductors, a cryogenic fluid supply line, and a cryogenic fluid return line. For example, processor 108 may obtain control data about superconducting cable 506. As discussed and shown in FIG. 5-8, superconducting cable 506 includes superconductors 716, cryogenic fluid supply line 518, and cryogenic fluid return line 512. As discussed in FIG. 5-8, the control data may include temperature of cryogenic fluid as measured at or near termination 502. Any other control data may also or instead be obtained by processor 508. For example, the control data may include any parameter relevant to the operation of superconducting cable 506 including temperature of the cryogenic fluid. For example, the control data may include cryogenic fluid pressure detected at termination 502, current amperage of the electrical power transmitted by superconducting cable 506 and measured at termination 502, voltage of the electrical power transmitted by superconducting cable 506 and measured at termination 502, resistance at termination 502, cryogenic fluid level measured at termination 502, cryogenic fluid flow rate measured at termination 502, mechanical strain on the superconducting layer (i.e., superconductors) and stabilizers of superconducting cable 506 measured at or near termination 502, vibrational frequency measured at termination 502, acoustic emissions measured at or near termination 502, ambient temperature at termination 502, humidity measured at termination 502, and the like, or any combination of such. Further, processor 508 may encode the control data for transmission. For example, processor 508 may convert the control data to signals representing the signals, which can be transmitted via pressure fluctuations and/or flow rate fluctuations. Further, processor 508 may encode the data into instructions for instructing another device, such as an electropneumatic positioner for controlling valve 616.

At step 904, changes in one or more parameters (e.g., pressure changes and/or flow rate changes) are created via a valve coupling the cryogenic fluid supply line and the cryogenic fluid return line in a first termination of the superconducting cable. The changes represent the control data and are not sufficiently large or frequent to impact operation of the superconducting cable. For example, processor 508 may transmit the control data after encoding for transmission via pressure and/or flow rate changes by controlling control valve 616 in termination 502 to inject the pressure changes and/or flow rate changes into cryogenic fluid return line 512.

At step 906, a pressure and/or flow rate sensor coupled to the cryogenic fluid return line at a second termination of the superconducting cable can detect the pressure changes and/or flow rate changes. For example, pressure and/or flow rate sensor 614 may detect the pressure fluctuations and/or flow rate fluctuations in cryogenic fluid return line 512 and transmit the pressure and/or flow rate readings to processor 510 via signal cable 526.

At step 908, the pressure changes and/or flow rate changes are decoded to extract the control data. For example, processor 510 may decode the pressure readings from pressure and/or flow rate sensor 614 to extract the control data transmitted by processor 508.

At step 910, operation of the superconducting cable may be controlled based at least in part on the control data extracted from the pressure readings and/or flow rate reading received at the second termination. For example, processor 510 may use the control data to instruct other devices and components within system 500 to control operation of superconducting cable 506. As one example, processor 510 may use control data including a temperature of the cryogenic fluid measured at termination 502 to modify cryogenic fluid flow from refrigeration unit 516 by changing control valve 520 using PID control 522. Other devices controlling various behaviors of superconducting cable 106 may also be instructed based on control data received via the pressure and/or flow rate readings.

FIG. 10 illustrates computing device 1001 that is representative of any system or collection of systems in which the various processes, programs, services, and scenarios disclosed herein may be implemented. Examples of computing device 1001 include, but are not limited to, microcontrollers, programmable logic controllers (PLC), field-programmable gate arrays (FPGA), direct digital controllers (DDC), desktop and laptop computers, tablet computers, mobile computers, and wearable devices. Examples may also include server computers, web servers, cloud computing platforms, and data center equipment, as well as any other type of physical or virtual server machine, container, and any variation or combination thereof. Accordingly, processor 110 may be computing device 1001.

Computing device 1001 may be implemented as a single apparatus, system, or device or may be implemented in a distributed manner as multiple apparatuses, systems, or devices. Computing device 1001 may include, but is not limited to, processing system 1002, storage system 1003, software 1005, communication interface system 1007, and user interface system 1009 (optional). Processing system 1002 is operatively coupled with storage system 1003, communication interface system 1007, and user interface system 1009.

Processing system 1002 loads and executes software 1005 from storage system 1003. Software 1005 includes and implements data transmission processes 1006, which are representative of the data transmission processes including encoding and decoding discussed with respect to the preceding figures, such as portions of method 400 and method 900 and as discussed as functionality performed by processors 108, 110, 508, and 510, each of which may be computing device 1001. In embodiments, multiple computing devices 1001 are used to implement portions of the process corresponding to respective terminations and control devices (e.g., pressure sensors, control valves, inductive coils, and the like). When executed by processing system 1002, software 1005 directs processing system 1002 to operate as described herein for at least the various processes, operational scenarios, and sequences discussed in the foregoing implementations. Computing device 1001 may optionally include additional devices, features, or functionality not discussed for purposes of brevity.

Referring still to FIG. 10, processing system 1002 may comprise a microprocessor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including data transmission processes 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing a data transmission process including encoding data, transmitting the signals to the inductive coupler, transmitting signals to the pumping system, decoding the data, and the like, as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded in to processing system 1002 and executed, transform a suitable apparatus, system, or device (of which computing device 1001 is representative) overall from a general-purpose computing system into a special-purpose computing system customized to support audio transformation processes in an optimized manner. Indeed, encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A system, comprising:
a superconducting cable comprising a plurality of superconductors that transmit electrical power at a first frequency;
a termination coupled to a first end of the superconducting cable, wherein the termination comprises:
a plurality of joints, wherein each joint couples at least one of the plurality of superconductors to a conductor, and
a conductive coil inductively coupled to the plurality of joints; and
a processor communicatively coupled to the conductive coil and configured to transmit signals representing control data of one or more parameters of the superconducting cable at a second frequency higher than the first frequency to the conductive coil.

2. The system of claim 1, further comprising:
a temperature sensor configured to detect a temperature of cryogenic fluid at the termination and transmit the temperature to the processor, wherein the control data comprises the temperature.

3. The system of claim 1, further comprising:
a second termination coupled to a second end of the superconducting cable, wherein the second termination comprises:
a second plurality of joints, wherein each joint of the second plurality of joints couples the at least one of the plurality of superconductors to a second conductor, and
a second conductive coil inductively coupled to the second plurality of joints; and
a second processor communicatively coupled to the second conductive coil and configured to receive the signals representing the control data.

4. The system of claim 3, wherein:
the second processor is further configured to transmit second signals representing different control data to the second conductive coil; and
the processor is further configured to receive the second signals.

5. The system of claim 3, further comprising:
a device for controlling one or more parameters of the superconducting cable; and
wherein the second processor is further configured to transmit instructions to the device based at least in part on the control data.

6. The system of claim 1, further comprising:
a current sensor configured to detect an amperage of the electrical power at the termination and transmit the amperage to the processor, wherein the control data comprises the amperage.

7. The system of claim 1, further comprising:
a pressure sensor configured to detect a pressure of cryogenic fluid at the termination and transmit the pressure to the processor, wherein the control data comprises the pressure.

8. A system, comprising:
a superconducting cable comprising:
one or more superconductors that transmit electrical power,
a cryogenic fluid supply line, and
a cryogenic fluid return line;
a termination coupled to a first end of the superconducting cable, wherein the termination comprises:
a valve coupling the cryogenic fluid supply line and the cryogenic fluid return line; and
a processor communicatively coupled to the valve and configured to transmit signals to the valve to create changes in one or more parameters of cryogenic fluid in the cryogenic fluid return line, wherein:
the changes in the one or more parameters of the cryogenic fluid represent control data of one or more parameters of the superconducting cable, and
the changes in the one or more parameters of the cryogenic fluid are not sufficiently large or frequent to impact behavior of the cryogenic fluid for operation of the superconducting cable.

9. The system of claim 8, further comprising:
a temperature sensor configured to detect a temperature of the cryogenic fluid in the cryogenic fluid supply line at the termination and transmit the temperature to the processor, wherein the control data comprises the temperature.

10. The system of claim 8, wherein the changes in the one or more parameters of the cryogenic fluid comprises one or both of pressure changes and flow rate changes, the system further comprising:
a second termination coupled to a second end of the superconducting cable, wherein the second termination comprises:
a sensor, the sensor comprising one or both of a pressure sensor and a flow rate sensor; and
a second processor communicatively coupled to the sensor and configured to decode readings from the sensor to identify the control data.

11. The system of claim 10, further comprising:
a device for controlling the one or more parameters of the superconducting cable; and
wherein the second processor is further configured to transmit instructions to the device based at least in part on the control data.

12. The system of claim 8, further comprising:
a current sensor configured to detect an amperage of the electrical power at the termination and transmit the amperage to the processor, wherein the control data comprises the amperage.

13. The system of claim 8, further comprising:
a sensor configured to:
detect a reading of the cryogenic fluid in the cryogenic fluid supply line at the termination, and
transmit the reading to the processor, wherein:
the reading is one or more of a pressure of the cryogenic fluid and a flow rate of the cryogenic fluid; and
the control data comprises the reading.

14. A method comprising:
obtaining control data related to a state of one or more parameters of a superconducting cable, wherein the superconducting cable comprises one or more superconductors configured to transmit electrical power, a cryogenic fluid supply line, and a cryogenic fluid return line;
transmitting, via a valve coupling the cryogenic fluid supply line and the cryogenic fluid return line in a first termination of the superconducting cable, changes in one or more parameters of cryogenic fluid in the cryogenic fluid return line representing the control data, wherein the changes in the one or more parameters of the cryogenic fluid are not sufficiently large or frequent to impact operation of the superconducting cable;
detecting the changes in the one or more parameters of the cryogenic fluid with a sensor coupled to the cryogenic fluid return line at a second termination of the superconducting cable; and
decoding the changes to extract the control data.

15. The method of claim 14, further comprising:
detecting a temperature of cryogenic fluid in the cryogenic fluid supply line at the termination, wherein the control data comprises the temperature.

16. The method of claim 14, wherein the changes in the one or more parameters of the cryogenic fluid comprise one or both of pressure changes and flow rate changes, the method further comprising:
detecting readings of the one or more parameters of the cryogenic fluid in the cryogenic fluid return line at a second termination of the superconducting cable; and
extracting the control data from the readings.

17. The method of claim 16, further comprising:
controlling the one or more parameters of the superconducting cable based at least in part on the extracted control data.

18. The method of claim 14, further comprising:
reading an amperage of the electrical power at the termination, wherein the control data comprises the amperage.

19. The method of claim 14, further comprising:
obtaining pressure readings, flow rate readings, or both of the cryogenic fluid in the cryogenic fluid supply line at the termination, wherein the control data comprises the pressure readings, the flow rate readings, or both.
